(19) United States
(12) Patent Application Publication
(10) Pub. No.: US 2023/0353885 A1
(43) Pub. Date: Nov. 2, 2023

(54) IMAGE PROCESSING SYSTEM AND METHOD FOR PROCESSING IMAGES

(71) Applicant: SONIC STAR GLOBAL LIMITED, Road Town (VG)

(72) Inventor: JIUN-I LIN, NEW TAIPEI CITY (TW)

(21) Appl. No.: 17/731,136

(22) Filed: Apr. 27, 2022

(51) Int. Cl. H04N 9/73; G06V 40/16

(52) U.S. Cl. CPC H04N 9/735; G06V 40/168; G06V 40/161

(57) ABSTRACT

The present disclosure provides an image processing system and a method for processing images. The image processing system includes an image sensor and a processing device. The image sensor is configured to capture an image. The processing device is configured to detect a face shown in the image, estimate locations of a plurality of facial features of the face, determine at least one non-occluded region of the face according to occluding conditions of the facial features, and perform a facial white balance operation on the image according to color data derived from within the non-occluded region. The facial features include at least one facial feature that is visible in the at least one non-occluded region.

### TECHNICAL FIELD

The present disclosure relates to an image processing system, and more particularly, to an image processing system for achieving the automatic white balance of a subject's face.

### DISCUSSION OF THE BACKGROUND

When a scene is recorded by a camera, the colors shown on an image may depend greatly on a light source that illuminates the scene. For example, when a white object is illuminated by yellow sunlight, the white object may appear yellow instead of white in the image. To correct such color shifts caused by the colors of light sources, the camera may perform an automatic white balance (AWB) operation to correct the white colors shown in the image.

Furthermore, if a person is shown in an image, a color shift of the person's skin can be noticeable since human faces tend to be observed in detail. Therefore, cameras may further perform another automatic white balance operation to correct the skin color. However, people may wear sunglasses or masks when being photographed, so the automatic white balance operation to correct the skin color can be challenging as the colors of the sunglasses and/or the masks may also be regarded as skin color. For example, if the face of a subject is partially covered by a blue mask, the facial AWB operation may tend to adjust the blue color, so the subject's face in a displayed image may appear too yellow after the facial AWB calibration.

### SUMMARY

One embodiment of the present disclosure provides an image processing system. The image processing system includes an image sensor and a processing device. The image sensor is configured to capture an image. The processing device is configured to detect a face shown in the image, estimate locations of a plurality of facial features of the face, determine at least one non-occluded region of the face according to occluding conditions of the plurality of facial features, and perform a facial white balance operation on the image according to color data derived from within the non-occluded region in which at least one facial feature is visible.

Another embodiment of the present disclosure provides a method for processing an image. The method comprises capturing, by an image sensor, an image; detecting a face shown in the image; estimating locations of a plurality of facial features of the face; determining at least one non-occluded region of the face according to occluding conditions of the facial features, wherein at least one of the facial features in the at least one non-occluded region is visible; and performing a facial white balance operation on the image according to color data derived from within the non-occluded region.

Since the image processing system and the method for processing images can detect the non-occluded regions of the face and sample the skin color within the non-occluded regions of the face for performing the facial white balance operation not affected by the colors of a mask and sunglasses that occlude the face, and thus, the facial white balance operation can correct the skin color more accurately.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures.

FIG. 1 shows an image processing system according to one embodiment of the present disclosure.

FIG. 2 shows a method for processing an image according to one embodiment of the present disclosure.

FIG. 3 shows an image according to one embodiment of the present disclosure.

FIG. 4 shows the sub-steps of a step in FIG. 2 according to one embodiment of the present disclosure.

FIG. 5 shows the feature points according to one embodiment of the present disclosure.

FIG. 6 shows an image processing system according to another embodiment of the present disclosure.

### DETAILED DESCRIPTION

The following description accompanies drawings, which are incorporated in and constitute a part of this specification, and which illustrate embodiments of the disclosure, but the disclosure is not limited to the embodiments. In addition, the following embodiments can be properly integrated to complete another embodiment.

References to “one embodiment,” “an embodiment,” “exemplary embodiment,” “other embodiments,” “another embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

In order to make the present disclosure completely comprehensible, detailed steps and structures are provided in the following description. Obviously, implementation of the present disclosure does not limit special details known by persons skilled in the art. In addition, known structures and steps are not described in detail, so as not to unnecessarily limit the present disclosure. Preferred embodiments of the present disclosure will be described below in detail. However, in addition to the detailed description, the present disclosure may also be widely implemented in other embodiments. The scope of the present disclosure is not limited to the detailed description, and is defined by the claims.

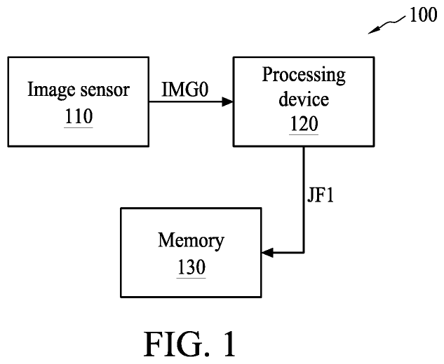

FIG. 1 shows an image processing system 100 according to one embodiment of the present disclosure. The image processing system 100 includes an image sensor 110, a processing device 120, and a memory 130. In the present embodiment, the processing device 120 may detect the face of a subject shown in an image captured by the image sensor 110, and the processing device 120 may determine whether any part of the face is occluded. If part of the face is occluded, it may be because the face is partially covered by a mask and/or sunglasses. In such case, the processing device 120 may locate at least one non-occluded region of the face that is not covered and perform a facial white balance operation on the image according to color data derived from within the non-occluded region. Therefore, the color of the mask or the sunglasses will not interfere with the result of the facial white balance operation, and the image quality of the image processing system 100 can thereby be improved.

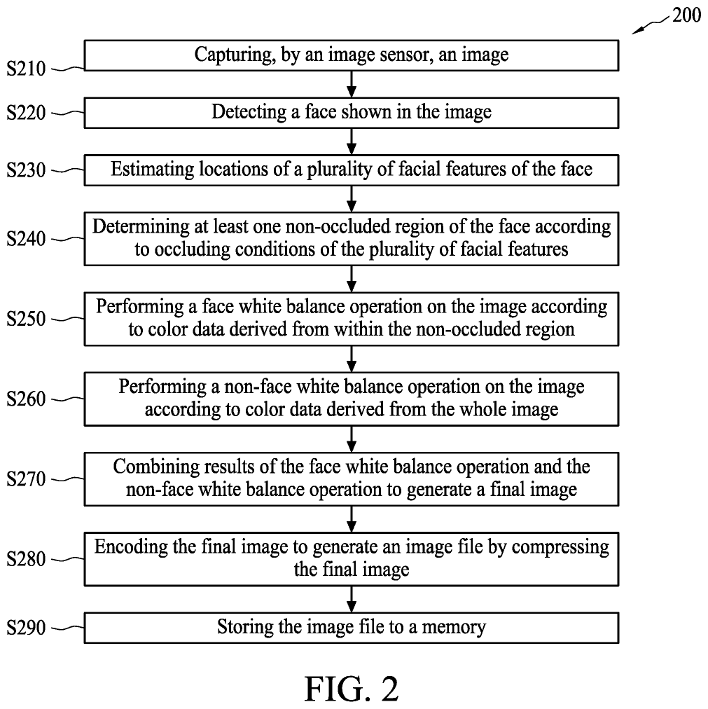

FIG. 2 shows a method 200 for processing an image according to one embodiment of the present disclosure. In the present embodiment, the method 200 includes steps S210 to S290, and may be performed by the image processing system 100.

In step S210, the image sensor 110 may capture an image IMG0, and in step S220, the processing device 120 may detect a face shown in the image IMG0. In some embodiments, there may be more than one face shown in the image IMG0. In such case, the processing device 120 may detect multiple faces and choose one face from the detected faces which occupies the greatest area in the image IMG0 for the facial white balance operation.

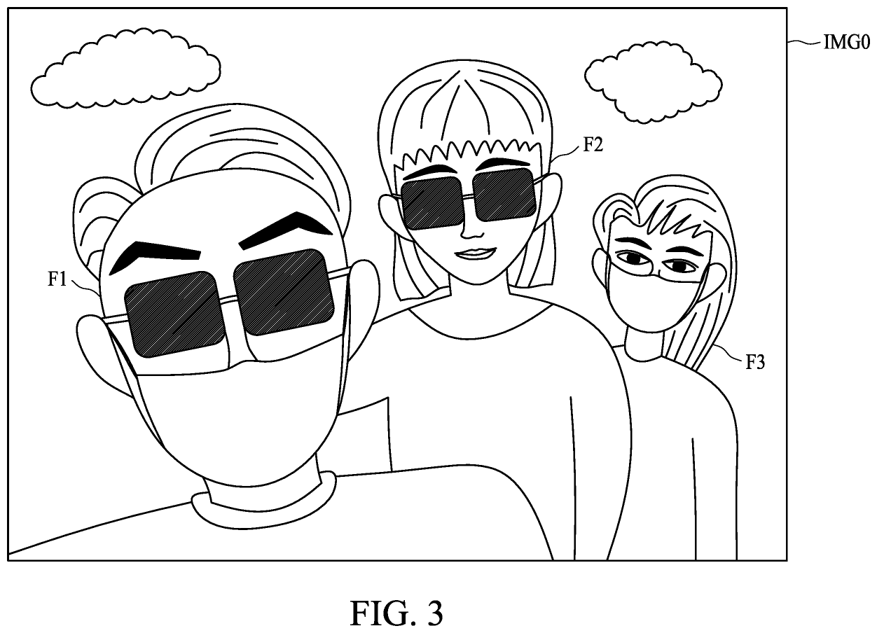

FIG. 3 shows an image IMG0 according to one embodiment of the present disclosure. As shown in FIG. 3, the image IMG0 may include faces F1, F2 and F3. In some embodiments, according to a face detection algorithm adopted by the method 200, the processing device 120 may detect all the faces F1, F2 and F3. However, since the face F1 occupies more area than the other faces do, the processing device 120 may select the face F1 and derive the color data of the face F1 for performing the facial white balance operation.

In step S230, the processing device 120 may further estimate the locations of facial features of the face F1. In some embodiments, the processing device 120 may also detect the face outline of the face in step S220 during the face detection, and the processing device 120 may estimate the locations of the facial features within the face outline. The facial features may correspond to eyes, a nose, and lips of the face F1. In some embodiments, the step S230 may be performed based on an artificial intelligence model or a machine learning model, and the artificial intelligence model or the machine learning model may be trained to detect faces shown in the image and predict the most likely locations of the facial features in the faces. That is, even if some of the facial features are covered by a mask or sunglasses, the locations of the facial features can still be estimated.

In the present embodiment, the image processing system 100 may be incorporated into a mobile device, and the processing device 120 may include a central processing unit of the mobile device. In addition, to operate the artificial intelligence model or the machine learning model for face detection, the processing device 120 may further include multiple processing units that can be used for parallel computing so as to accelerate the speed of face detection. However, the present disclosure is not limited thereto. In some other embodiments, other types of face detection algorithms may be implemented to detect the faces and estimate the locations of the facial features, and the processing device 120 may omit the processing units or include some other types of processing units according to the computational requirements.

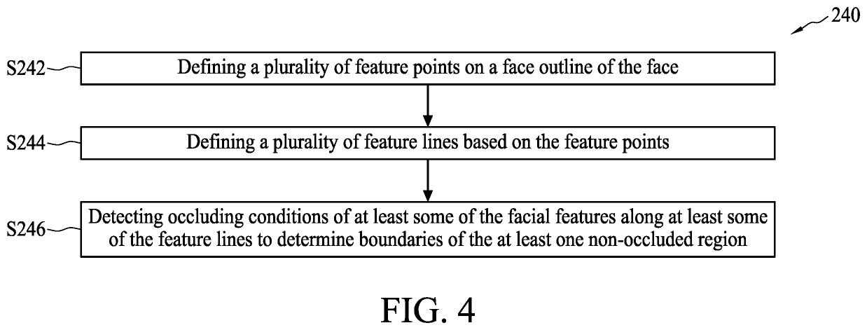

In step S240, after the locations of the facial features are obtained by estimation, the processing device 120 may further determine at least one non-occluded region of the face according to occluding conditions of the facial features. FIG. 4 shows the sub-steps of step S240 according to one embodiment of the present disclosure. As shown in FIG. 4, step S240 may include sub-steps S242 to S246.

In sub-step S242, the processing device 120 may define feature points on the face outline of the face F1, and in sub-step S244, the processing device 120 may further define a plurality of feature lines according to the feature points defined in sub-step S242. For example, the processing device 120 may locate the coordinates of the feature points along the face outline of the face F1, and define the feature lines by connecting the corresponding feature points. In the present embodiment, the processing device 120 may scan the face one feature line at a time to see if any of the facial features is occluded along the feature line. In this way, the boundaries of the non-occluded region can be determined in step S246.

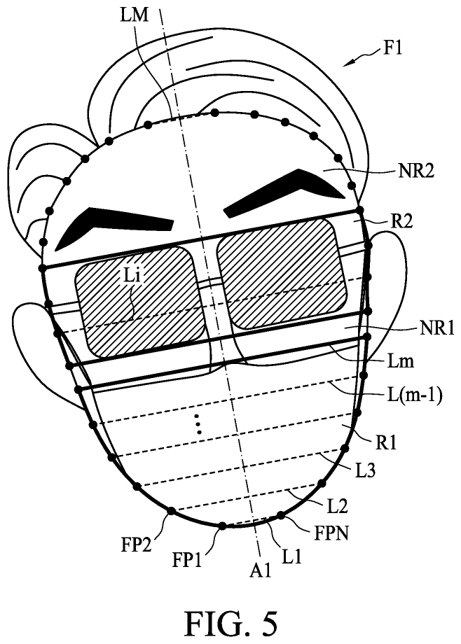

FIG. 5 shows the feature points FP1 to FPN defined in sub-step S242 according to one embodiment of the present disclosure. As shown in FIG. 5, each of the feature lines L1 to LM has a first end connecting to a feature point and a second end connecting to another feature point. For example, the feature line L1 has a first end connecting to the feature point FP1 and a second end connecting to the feature point FP2. Furthermore, the processing device 120 may determine a symmetry axis A1 of the face F1, and the first and the second ends of each of the feature lines L1 to LM are on different sides of the symmetry axis A1. In the present embodiment, M and N are integers greater than 1.

In the present embodiment, there is a boundary between a non-occluded region and an occluded region which is somewhere between a first feature line and a second feature line that is adjacent to the first feature line if at least one facial feature is occluded along the first feature line and no facial feature is occluded along the second feature line. That is, the processing device 120 may determine whether at least one facial feature is occluded along a first feature line and no facial feature is occluded along a second feature line of the feature lines, and if affirmative, the processing device 120 would choose one of the first feature line, the second feature line, or a line between the first feature line and the second feature line to be a boundary of a non-occluded region.

In some embodiments, since a mask is a commonly worn object that may cover a face, the method 200 may scan regions likely covered by a mask with a higher priority. For example, normally, a mask may cover a lower part of a face; therefore, in step S246, the processing device 120 may start the detection of occluding conditions from a feature line L1 at the bottom of the face F1. If the processing device 120 determines that a facial feature of the face F1 is occluded along the bottom feature line L1, it may mean that the face F1 is covered by a mask. In such case, the processing device 120 may choose the feature line L1 as a lower boundary of the occluded region R1 covered by the mask, and the processing device 120 proceeds to detect occluding conditions of the facial features that are above the bottom feature line L1 so as to find an upper boundary of the occluded region R1.

In the example of FIG. 5, the processing device 120 will detect the occluding conditions of the facial features along the feature lines, such as L2 and L3, that are above the feature line L1. When the processing device 120 detects the facial features along a feature line Lₘ, and determines that no facial feature is occluded along the feature line Lₘ, it may choose the feature line Lₘ or the adjacent feature line L₍ₘ₋₁₎ that is below the feature line Lₘ as the upper boundary of the mask-covered region R1. In the present embodiment, m is an integer greater than 1 and less than M.

Furthermore, since sunglasses are another commonly worn object that may cover the face, the method 200 may give a higher priority to the regions corresponding to eyes likely covered by the sunglasses on a face. In the example of FIG. 5, when a facial feature corresponding to the eyes of the face F1 is determined to be occluded along a feature line Lᵢ, the processing device 120 may further detect the occluding conditions of facial features along feature lines that are on a first side, such as an upper side, of the feature line Lᵢ to find an upper boundary of an occluded region R2 covered by the sunglasses. Also, the processing device 120 may detect the occluding conditions of facial features along feature lines that are on a second side, such as a bottom side, of the feature line Lᵢ to find a bottom boundary of the occluded region R2. In the present embodiment, i is an integer greater than 1 and smaller than M.

Since the boundaries of the occluded regions may also be the boundaries of the non-occluded regions, the boundaries of the non-occluded regions can be found after the boundaries of the occluded regions are detected. In step S250, after the boundaries of the non-occluded regions NR1 and NR2 are determined, the processing device 120 may perform a facial white balance operation on the image IMG0 according to the color data derived from within the non-occluded regions NR1 and NR2 of the face F1. In such case, since the color data used for facial white balance will only be derived from within the non-occluded regions NR1 and NR2 of the face F1, the colors of the mask and the sunglasses will not be taken into account, and thus, the facial white balance operation can correct the skin color more accurately. In some embodiments, the image IMG0 may be divided into a number of blocks, and the color data may be derived from calculating the average color values of R. G, and B in those blocks within the non-occluded regions NR1 and NR2.

In addition, since colors of objects outside of the faces may also be shifted by the light sources and require corrections, a non-facial white balance operation, or a global white balance operation, may also be performed. For example, in step S260, the processing device 120 may perform the non-facial white balance operation on the image IMG0. In some embodiments, since the non-facial white balance operation can be performed by deriving the color data from the whole image without performing face detection, step S260 may be performed before the face detection in step S220 or may be performed in parallel with step S220.

In step S270, the results of the facial white balance operation and the non-facial white balance operation may be combined to generate a final image IMG1. In some embodiments, the results of the facial white balance operation and the non-facial white balance operation may be combined using weightings related to the area occupied by the faces in the image IMG0. For example, if the area of the faces occupies most of the image IMG0, then the weighting of the facial white balance operation will be greater. On the other hand, if the area of the faces takes up only a small portion of the image IMG0, then the weighting of the facial white balance operation will be smaller and the weighting of the non-facial white balance operation will be greater.

Furthermore, as shown in FIG. 2, the method 200 may further encode the final image IMG1 to generate an image file JF1 in step S280 so as to reduce the size of the final image IMG1. That is, the encoding can be performed to compress the final image IMG1. For example, the final image IMG1 may be encoded to be a JPEG file. After an encoded image file JF1 is generated, the encoded image file JF1 can be stored to the memory 130 in step S290.

In some embodiments, the encoding operation in step S280 can be performed by the processing device 120. However, the present disclosure is not limited thereto. In other embodiments, the image processing system 100 may further include an image encoder for encoding the final image IMG1 in step S280.

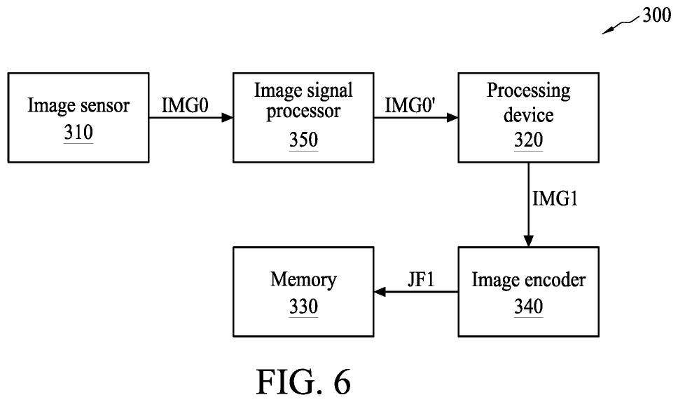

FIG. 6 shows an image processing system 300 according to another embodiment of the present disclosure. As shown in FIG. 6, the image processing system 300 may include an image encoder 340 for encoding an image, and an encoded image file JF1 can be stored to a memory 330.

In addition, in the present embodiment, the image processing system 300 may further include an image signal processor 350. The image signal processor 350 may downscale an image IMG0 captured by an image sensor 310, and a processing device 320 may detect a face using a downscaled image IMG0 received from the image signal processor 350. By reducing the size of the image IMG0, a computing load required by face detection and facial features estimation in steps S220 and S230 may also be reduced. Furthermore, the image signal processor 350 may further be used to provide white balance statistics for the processing device 320 to perform the facial white balance operation and the non-facial white balance operation.

In summary, the image processing system and the method for processing images provided by embodiments of the present disclosure can detect non-occluded regions of a face and derive color data from within the non-occluded regions of the face for the facial white balance operation. In so doing, the facial white balance operation will not be affected by the colors of a mask and/or sunglasses on the face and can thus correct the skin color more accurately.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods or steps, presently existing or later to be developed, that perform substantially the same function or achieve substantially the same result as the corresponding embodiments described herein, may be utilized according to the present disclosure. Accordingly, the appended claims are intended to include within their scope such processes, machines, manufacture, compositions of matter, means, methods and steps.

What is claimed is:

1. An image processing system, comprising:
an image sensor configured to capture an image; and
a processing device configured to detect a face shown in the image, estimate locations of a plurality of facial features of the face, determine at least one non-occluded region of the face according to occluding conditions of the facial features, and perform a facial white balance operation on the image according to color data derived from within the at least one non-occluded region;
wherein the facial features include at least one facial feature that is visible in the at least one non-occluded region.

2. The image processing system of claim 1, wherein:
the processing device is configured to detect a face outline of the face and estimate the locations of the facial features within the face outline based on an artificial intelligence model.

3. The image processing system of claim 1, further comprising:
an image signal processor configured to downscale the image captured by the image sensor to generate a downscaled image;
wherein the processing device receives the downscaled image from the image signal processor and detects the face using the downscaled image.

4. The image processing system of claim 3, wherein:
the image signal processor is further configured to provide white balance statistics for the processing device to perform the facial white balance operation.

5. The image processing system of claim 1, wherein:
the processing device is further configured to detect a face outline of the face, define a plurality of feature points on the face outline, define a plurality of feature lines based on the feature points, and detect conditions of at least some of the facial features along at least some of the feature lines to determine boundaries of the at least one non-occluded region;
wherein each of the feature lines has a first end connecting to a feature point of the feature points and a second end connecting to another feature point of the feature points.

6. The image processing system of claim 5, wherein:
the processing device is further configured to determine a symmetry axis of the face; and
the first and the second ends of each of the feature lines are on different sides of the symmetry axis, respectively.

7. The image processing system of claim 5, wherein:
when the processing device determines that at least one facial feature is occluded along a first feature line of the feature lines and no facial feature is occluded along a second feature line of the feature lines, the processing device chooses one of the first feature line, the second feature line, or a line between the first feature line and the second feature line to be a boundary of a non-occluded region;
wherein the second feature line is adjacent to the first feature line.

8. The image processing system of claim 5, wherein:
when the processing device determines that a facial feature corresponding to eyes of the face is occluded along a first feature line, the processing device detects occluding conditions of at least some of the facial features along feature lines that are on a first side of the first feature line to find a first boundary of an occluded region, and detects occluding conditions of at least some of the facial features along feature lines that are on a second side of the first feature line to find a second boundary of the occluded region.

9. The image processing system of claim 5, wherein:
when the processing device determines that a facial feature of the face is occluded along a bottom feature line of the feature lines, the processing device detects occluding conditions of at least some of the facial features along feature lines that are above the bottom feature line to find a boundary of an occluded region where the facial feature is located.

10. The image processing system of claim 1, wherein:
the processing device is further configured to perform a non-facial white balance operation on the image according to color data derived from the whole image and combine results of the facial white balance operation and the non-facial white balance operation to generate a final image.

11. The image processing system of claim 10, further comprising:
an image encoder configured to encode the final image to generate an image file by compressing the final image; and
a memory configured to store the image file.

12. A method for processing an image, comprising:
capturing, by an image sensor, an image;
detecting a face shown in the image;
estimating locations of a plurality of facial features of the face;
determining at least one non-occluded region of the face according to occluding conditions of the facial features, wherein the facial features include at least one facial feature that is visible in the at least one non-occluded region; and
performing a facial white balance operation on the image according to color data derived from within the at least one non-occluded region.

13. The method of claim 12, wherein:
the step of detecting a face comprises detecting a face outline of the face shown in the captured image; and
the step of estimating facial feature locations comprises estimating the locations of the facial features within the face outline;
wherein the steps of detecting and estimating are based on an artificial intelligence model.

14. The method of claim 12, further comprising:
downscaling the image captured by the image sensor to generate a downscaled image;
wherein the step of detecting a face comprises detecting the face using the downscaled image.

15. The method of claim 13, wherein the step of determining at least one non-occluded region of the face comprises:
defining a plurality of feature points on the face outline of the face;
defining a plurality of feature lines based on the feature points; and
detecting occluding conditions of at least some of the facial features along at least some of the feature lines to determine boundaries of the at least one non-occluded region;
wherein each of the feature lines has a first end connecting to a feature point of the feature points and a second end connecting to another feature point of the feature points.

16. The method of claim 15, further comprises:
determining a symmetry axis of the face;
wherein the first and the second ends of each of the feature lines are on different sides of the symmetry axis, respectively.

17. The method of claim 15, wherein the step of determining at least one non-occluded region of the face further comprises:
determining if at least one facial feature is occluded along a first feature line of the feature lines and no facial feature is occluded along a second feature line of the feature lines, if affirmative,
choosing one of the first feature line, the second feature line, or a line between the first feature line and the second feature line to be a boundary of a non-occluded region;
wherein the second feature line is adjacent to the first feature line.

18. The method of claim 15, wherein the step of determining the at least one non-occluded region of the face further comprises:
determining if a facial feature corresponding to eyes of the face is occluded along a first feature line, if affirmative,
detecting occluding conditions of at least some of the facial features along feature lines that are on a first side of the first feature line to find a first boundary of an occluded region; and
detecting occluding conditions of at least some of the facial features along feature lines that are on a second side of the first feature line to find a second boundary of the occluded region.

19. The method of claim 15, wherein the step of determining the at least one non-occluded region of the face further comprises:
determining if a facial feature of the face is occluded along a bottom feature line of the feature lines, if affirmative,
detecting occluding conditions of at least some of the facial features along feature lines that are above the bottom feature line to find a boundary of an occluded region where the facial feature is located.

20. The method of claim 12, further comprising:
performing a non-facial white balance operation on the image according to color data derived from the whole image; and
combining results of the facial white balance operation and the non-facial white balance operation to generate a final image;
encoding the final image to generate an image file by compressing the final image; and
storing the image file to a memory.
